(19) United States
(12) Patent Application Publication
(10) Pub. No.: US 2006/0059294 A1
(43) Pub. Date: Mar. 16, 2006

(54) Expandable bus topology for peripheral devices of straddle vehicles

(76) Inventors: Kevin T. Smith, Louisville, KY (US); Shawn T. Northener, Louisville, KY (US); John W. Mayhugh, Louisville, KY (US); Bradley N. Harris, Jeffersonville, IN (US); Brian D. Glenn, Goshen, KY (US); Thad C. Switzer, Lexington, KY (US)

Correspondence Address: KING & SCHICKLI, PLLC, 247 NORTH BROADWAY, LEXINGTON, KY, 40507, US

(21) Appl. No.: 10/942,647

(22) Filed: Sep. 16, 2004

(51) Int. Cl. G06F 13/20

(52) U.S. Cl. 710/313

(57) ABSTRACT

A straddle vehicle includes an expandable bus topology to operate one or more peripheral devices from a single location on the straddle vehicle, the peripheral devices being physically distributed about the straddle vehicle. The topology includes a bus trunk and a main hub controller. The main hub controller attaches directly to the peripheral devices and/or other bus trunks. Additional peripheral devices attach to the main hub or other controllers. A user interface module operates from a single location on the handlebar as the sole user controller for the peripheral devices. For easy operation, the module includes a four-way rocker and other switches manipulated by a user's thumb. Preferably, the bus topology operates according to a controller area network (CAN) protocol. Peripheral devices include cell phones, CD players, MP3 players, radar detectors, navigation devices and radios, such as AM, FM, XM, WB, GMRS or CB. Methods for control are also described.

### FIELD OF THE INVENTION

The present invention relates generally to straddle vehicles, especially motorcycles. Particularly, it relates to a bus topology expandable to accommodate one or more peripheral devices distributed about the straddle vehicle. In one aspect, a user interface module controls the peripheral devices from a single location, especially a handlebar. In another aspect, the topology includes hub controllers and bus trunks operating according to a desired protocol, such as a controller area network (CAN) protocol. Peripheral devices include radios, music players, radar detectors, cell phones and the like.

### BACKGROUND OF THE INVENTION

Straddle vehicles generally include motorcycles, all-terrain vehicles, jet-skis, snowmobiles and the like. In recent years, manufacturers and retailers have increasingly added peripheral devices to the vehicles to meet growing consumer demands and/or provide features and functionality to gain advantage over competitors. For example, today's motorcycles are regularly offered with robust radios having multi-frequency capabilities whereas years ago they did not even contemplate radios. The same is true of radar detectors, music players and other similar peripheral devices.

Problematically, control over each of these devices requires users to interface directly with the switches of the actual device. Because devices can have great quantities of switches and varieties, users sometimes find operation difficult, especially while riding the vehicle. Safety may also be implicated if the devices are distributed about the vehicle chassis in positions where users need to divert their attention from the safe operation of the vehicle. In addition, as users desire to increase the number of peripheral devices on their vehicles, modifications to the vehicle require additional dedicated wiring harnesses and dedicated control. Moreover, straddle vehicles often carry two or more riders, each having helmets including speakers for listening to the peripheral devices as well as intercoms to communicate between the riders. The wiring harnesses and control must then also contemplate multiple-rider scenarios.

In an attempt to overcome the foregoing problems, some prior art systems connect multiple peripheral devices into “all-in-one” structures. For example, the AudioBoss model AB-Im includes speakers, intercoms and a variety of peripheral devices, such as an MP3 player, a radar detector, a cell phone and a 2-way radio, in an integrated intercom structure. Although each rider can hear the peripheral device presently in use, users must still control the device (e.g., volume control, frequency or channel switches) via the buttons, switches and knobs of the control panel of the actual device. Thus, problems remain.

Accordingly, a need exists in the straddle vehicle arts for easily operating one or more peripheral devices, despite the devices having numerosity in their control panel knobs, switches and buttons. This need further includes an ability to robustly accommodate peripheral devices added to the vehicle upon user demand, even if the peripheral devices are generally incompatible. An example of incompatible devices includes a radar detector and a cell phone.

### SUMMARY OF THE INVENTION

The above-mentioned and other problems become solved by applying the principles and teachings associated with the hereinafter described bus topology for peripheral devices of a straddle vehicle, including an expandable topology to accommodate peripheral devices added after initial configuration. Single point control therefor is also provided.

In one aspect, the topology includes a main hub controller and/or secondary hub controllers. Each controller attaches to a bus trunk and one or more peripheral devices. The main hub controller can also interface with additional bus trunks to accommodate additional peripheral devices added to the straddle vehicle by the user. Further, a user interface module connects to the main hub controller. Users initiate commands with the module for controlling the peripheral devices and the main hub controller responds accordingly. Preferably, the controller(s), bus trunk(s), peripheral device(s) and user interface module operate according to a controller area network (CAN) protocol. CAN protocol typically conforms to ISO 11898 for serial data communication. Peripheral devices include cell phones, CD players, MP3 players, radar detectors and radios, such as AM, FM, XM, WB, GMRS or CB. Methods for control thereof are also described.

In another aspect, the user interface module controls one or more peripheral devices from a single point of control, especially a handlebar. The module has a four-way rocker switch, a preset switch and a mode switch. Together, the switches accommodate a wide-range of user selections for a vastly varying number of peripheral devices. The switches reside on the module beneath the handlebar where a user can easily manipulate them with a thumb while still grasping the handlebar with one or more fingers of the same hand.

These and other embodiments, aspects, advantages and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification illustrate several aspects of the present invention and together with the description serve to explain certain principles of the invention. In the drawings:

FIGS. 1-6 are diagrammatic views in accordance with the teachings of the present invention of representative expandable bus topologies for control of one or more peripheral devices physically distributed about a straddle vehicle;

FIG. 7 is a diagrammatic view in accordance with the teachings of the present invention of a representative hub controller in the bus topology;

FIG. 8 is a diagrammatic view in accordance with the teachings of the present invention of a representative user interface module; and

FIGS. 9-10 are diagrammatic views in accordance with the teachings of the present invention of representative state diagrams useful with the user interface module of FIG. 8.

Reference will now be made in detail to the present preferred embodiments of the invention, examples of which are illustrated in the accompanying drawings.

### DETAILED DESCRIPTION OF THE PREFERRED EMBODIMENTS

In the following detailed description of the preferred embodiments, 10 reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that process or other changes may be made without departing from the scope of the present invention. The following detailed description is, therefore, not to be taken in a limiting sense and the scope of the present invention is defined only by the appended claims and their equivalents. In accordance therewith, a bus topology expandable to meet differing varieties and quantities of peripheral devices distributed about a straddle vehicle is hereinafter described. The topology also includes an option for user to control the one or more peripheral devices from a single location on the straddle vehicle and to do so with robust functionality from a limited number of ergonomically positioned switches.

As used herein, straddle vehicles include, but are not limited to, motorcycles, all-terrain vehicles, jet-skis, snowmobiles and the like. Since these are well known, they will not be further described herein in detail. Some of the more popular manufacturers of straddle vehicles include Harley Davidson, Honda, Yamaha, BMW, Kawasaki, Polaris, and Ski-doo. Peripheral devices of the invention include, but are not limited to, cell phones, CD players, MP3 players, radar detectors, global positioning or other navigation devices and radios, such as AM, FM, XM, WB, GMRS or CB. They even include user interface module(s) for operating one or more of the other peripheral devices.

As further used herein, “topology” refers to a physical and logical/electrical layout of components. A bus, on the other hand, refers to the near-simultaneous communication of information over groups of wires to one or more peripheral devices. As is typical in a bus, all peripheral devices continually “listen” or “watch” for information directed or addressed thereto. Then, upon receipt of such information, they act or respond according to the command therein. Broadly stated, “information” includes, but is not limited to, one or more of data, commands, or addresses. Some advantages of bus topologies over the prior art's use of dedicated systems includes: the use of relatively little cable/wiring for the varieties and quantities of peripheral devices; easy expansion to accommodate additional peripheral devices; simplicity and flexibility.

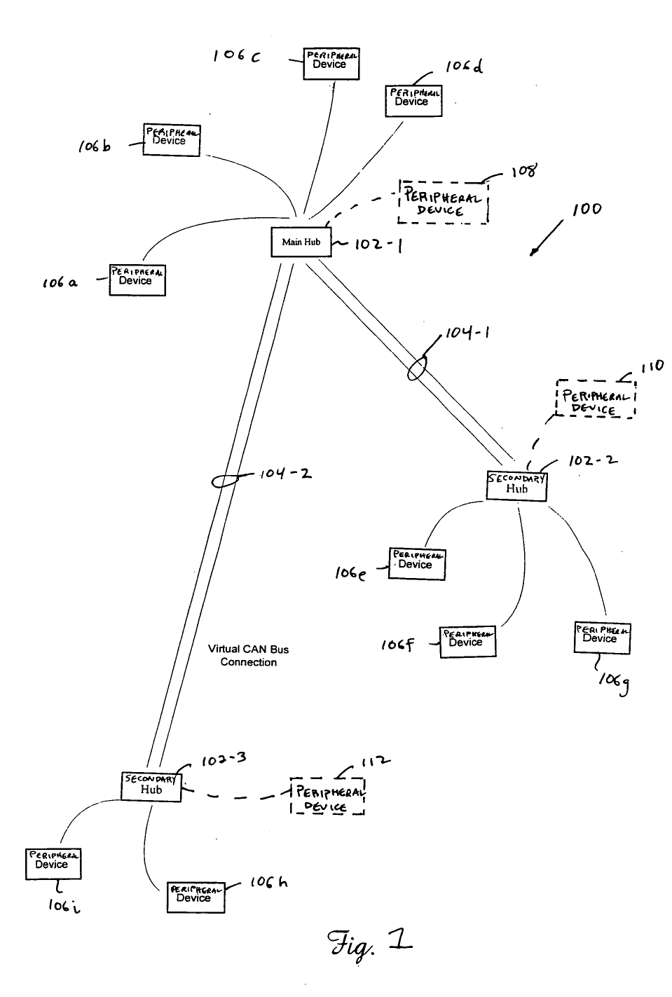

With reference to FIG. 1, a bus topology in accordance with the present invention is shown as 100. In general, it comprises one or more hub controllers 102 and one or more bus trunks 104. One or more peripheral devices 106 connect to the hub controllers and can be found physically distributed about the straddle vehicle as a user might desire. For example, a CD player may be positioned aft of a straddle vehicle seat while a citizen's band (CB) radio may be positioned on or near the straddle vehicle handlebar. In this manner, users can adorn their straddle vehicle however they see fit. Similarly, the physical placement of the bus trunk and controllers can also be anywhere desired, but will generally be selected in consideration of environmental protection and accessibility.

In one embodiment, the bus trunk, controllers and peripheral devices operate according to the controller area network (CAN) protocol defined presently as ISO standard 11898 for serial data communication. At first, CAN was developed for the automotive industry but today finds widespread use in other disciplines, such as industrial automation. The CAN protocol has four general message types including the data frame, the remote frame, the error frame and the overload frame to communicate information along the bus trunk. For a complete description of the various nuances, species and particulars of the CAN protocol, including the number of bits, the arrangement of message identifiers, the timing, the priority, bus speeds, bus termination, cabling and connector requirements, etc., the present invention herein incorporates, by reference, the entirety of the ISO 11898 standard defined by the International Organization for Standardization. However, the present invention is not limited to this protocol and other known or hereinafter invented protocols or rules for governing the format and timing exchange of bus information are embraced herein. Other embodiments, for example, contemplate utilization of RS-232 or J1850 protocols.

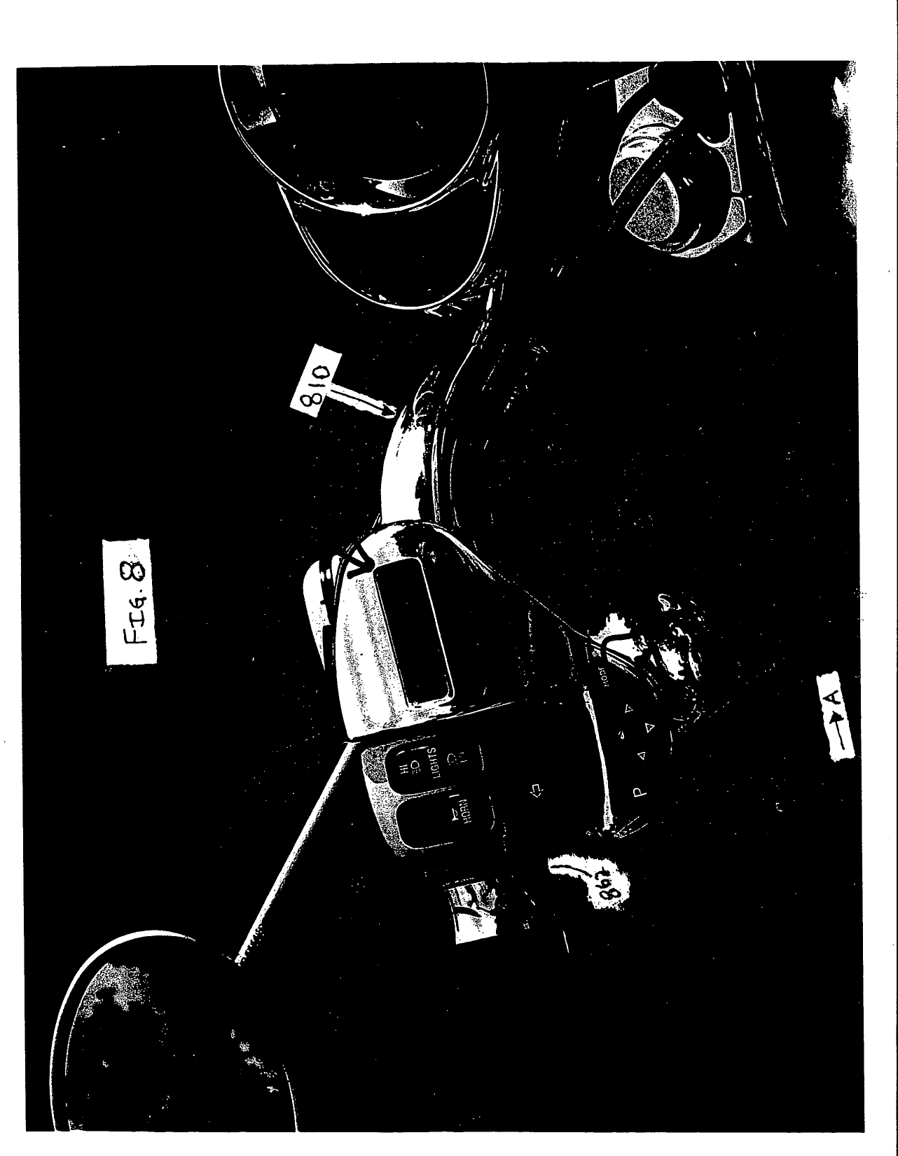

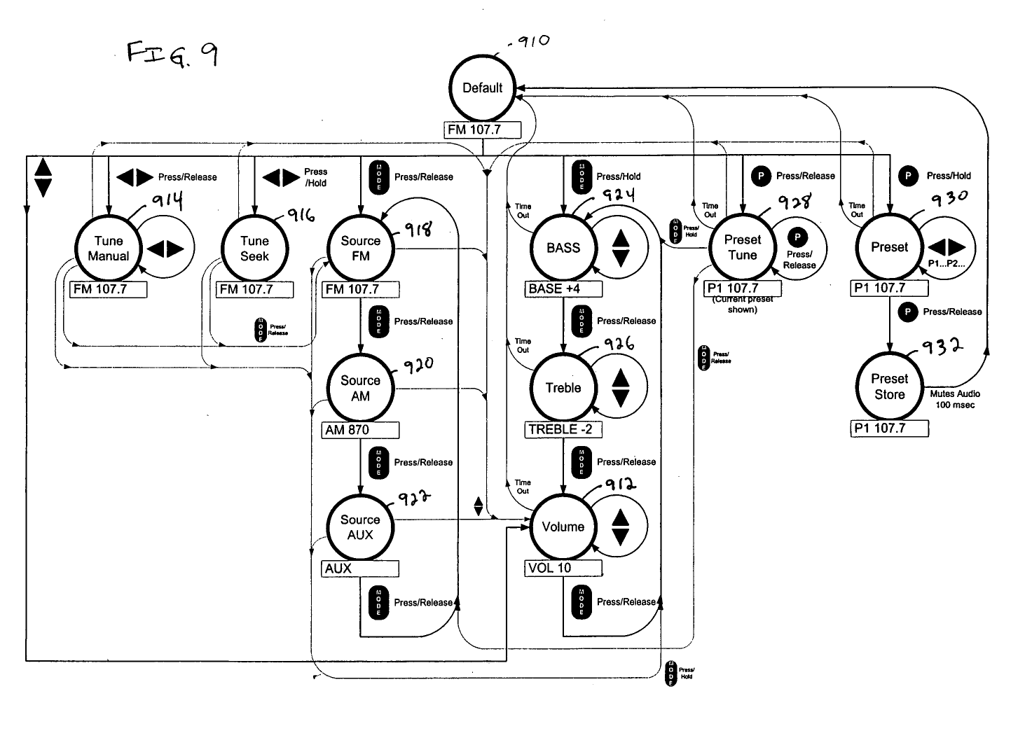

With more specificity, FIG. 1 depicts a main hub controller 102-1 connected to two bus trunks 104-1 and 104-2 as well as a variety of peripheral devices 106a, 106b, 106c and 106d. At this point, skilled artisans should appreciate that the number and arrangement of bus trunks and peripheral devices shown is merely representative. As will be seen in other embodiments, these will vary. They may be as few as one or as great as three or more with adaptability for many more. In either event, the main hub controller functions as the topology centerpiece for the architecture. As described in FIG. 7 below, it is preferred the main hub controller embodies a commercially available microprocessor interfaced with functional components that accommodate the physical and electrical environments in which straddle vehicles are regularly operated. Alternatively, it embodies a standalone processor or a group of dedicated components behaving collectively as a controller. It may even reside within one or more peripheral device housings. In either event, its role includes facilitating information or message traffic between each of the secondary hubs 102-2, 102-3 and any peripheral device(s) of any of the hubs 102 according to the protocol desired or selected by the manufacturer. It also takes user initiated commands entered on a user interface module to control the operation of the one or more peripheral devices. In FIG. 1, the user interface module is any of the peripheral devices 106 and connects directly or indirectly to the main hub controller. Still other functionality of the main hub controller includes keeping track of virtual or actual connections in the topology and listing the peripheral devices found therein. In this manner, it facilitates passing of information (e.g., message forwarding) between the peripheral devices. It may even include function related to operation of the straddle vehicle, such as controlling power/ignition modes, troubleshooting, or other. In addition, the main hub controller serves to adaptively configure new peripheral devices within the topology whenever a user desires to add one. It does so by communicating directly with the new peripheral device and establishing/initializing its inclusion in the topology. When complete, the new peripheral device acts as any other device already established. Dashed lines about peripheral devices 108, 110 and 112 indicate a new peripheral device can be included anywhere. As will be described with reference to the user interface module of FIG. 8, a user will have the option, if desired, to control all peripheral devices from a single location on the straddle vehicle.

The secondary hubs 102 have generally the same circuitry/arrangement and behave the same as the main hub controller except that only message traffic of attendant peripheral devices travels there through. Physically, and unlike the main hub controller which can connect to any number of bus trunks, the secondary hub controllers only connect to single bus trunks. In this instance, secondary hub controller 102-2 connects to bus trunk 104-1 and secondary hub controller 102-3 connects to bus trunk 104-2. Meanwhile, the main hub controller 102-1 connects to two bus trunks 104-1, and 104-2. As skilled artisans will recognize, the resulting topology resembles a star topology where all information or message traffic passes via the main hub controller. The advantage of a star topology includes the ability to better troubleshoot or isolate failures between branches emanating from the main hub.

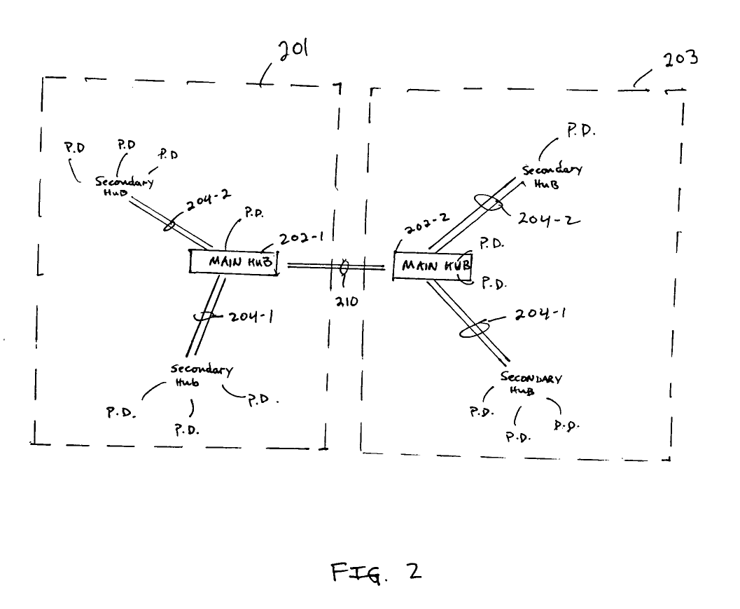

In FIG. 2, the star topology of the invention could also be a distributed star topology having one or more star topologies 201, 203 connected to one another. In this example, one or more main hub controllers 202-1, 202-2 each connect to one another via bus trunk 210. In turn, each main hub controller has one or more secondary hub controllers connected via bus trunks 204-1, 204-2. Whether main or secondary, each hub controller can further have any number of peripheral devices (P.D.) connected thereto. Although not shown, the topology of the invention could also resemble rings, meshes, distributed star, cascaded bridges, tree, star-wired or other well known or hereinafter invented arrangement.

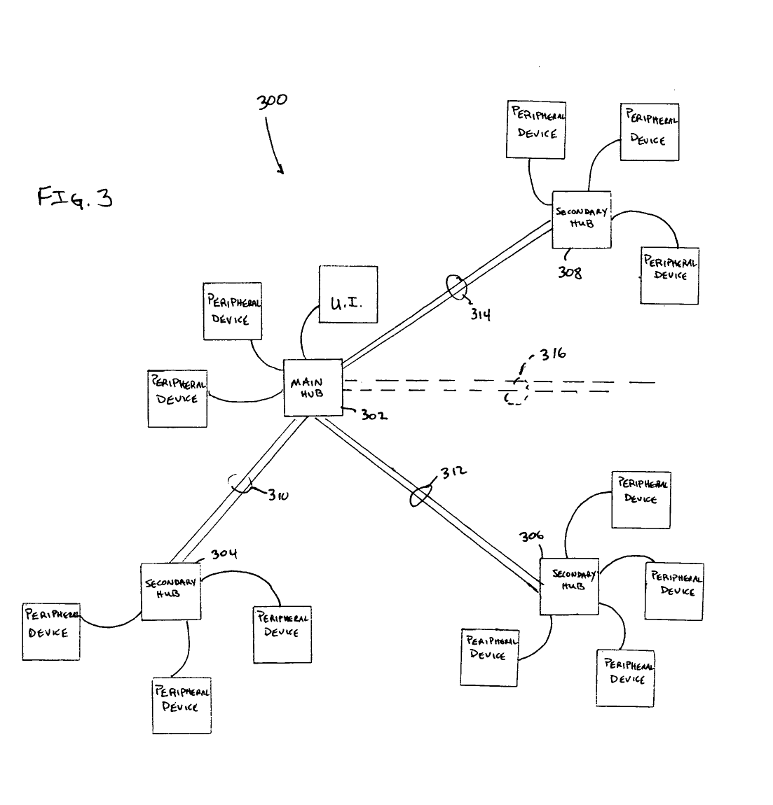

As another example of a bus topology for accommodating peripheral devices of a straddle vehicle, consider the bus topology 300 of FIG. 3. Herein, a main hub controller 302 connects with three secondary hub controllers 304, 306, 308. In between, bus trunks 310, 312, 314 exist to provide physical and electrical connection according to CAN or other protocols. Peripheral devices and a user interface (U.I.) module are scattered about each hub as desired. Of course, users may modify the design to include more or less peripheral devices or more or less U.I. modules relative to any of the given hubs. A fourth bus trunk 316 is also shown to indicate how still more secondary hubs, and attendant peripheral device(s) (including U.I. modules), may be joined to the topology.

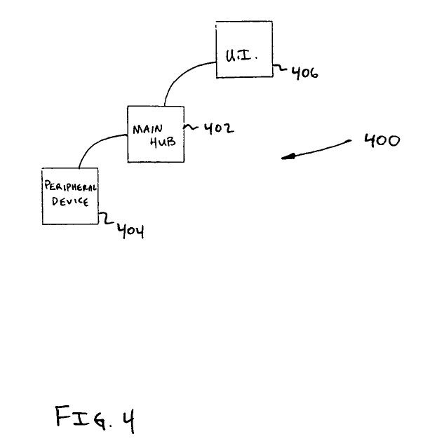

In contrast, FIG. 4 shows a meager topology 400 where only a single hub controller 402 exists. In this example, a main hub controller 402 connects to a single peripheral device 404 and a single user interface module 406. It does not, however, connect to any bus trunks or attendant secondary hub controllers or their peripheral devices. The reason, some users may initially only purchase a single peripheral device and a single user interface module. As is known, any individual peripheral device can sometimes cost users upwards of hundreds of dollars or more. Yet, the adaptability of the topology to accommodate future additions of peripheral devices is not diminished.

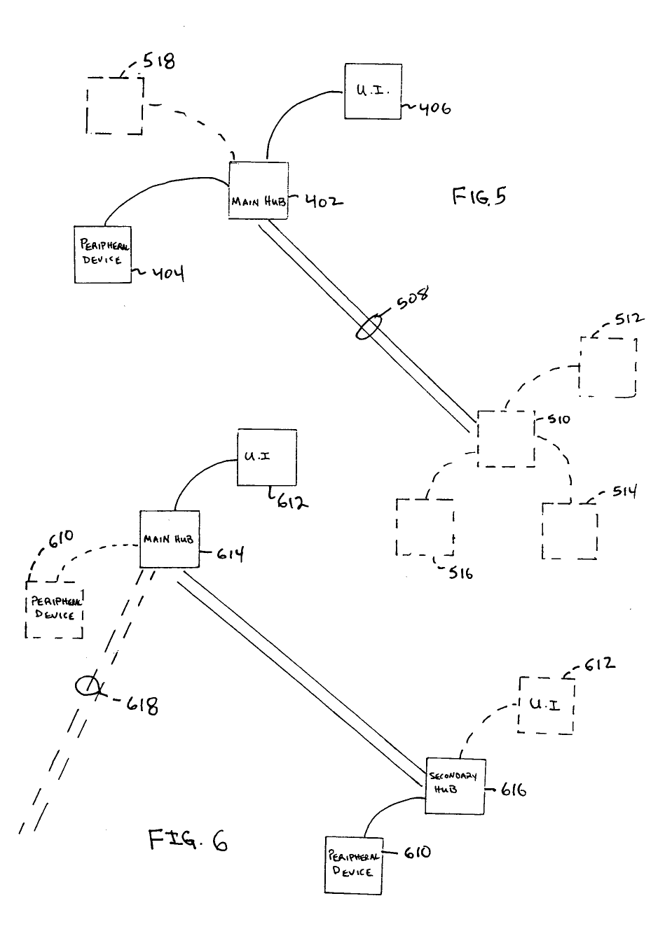

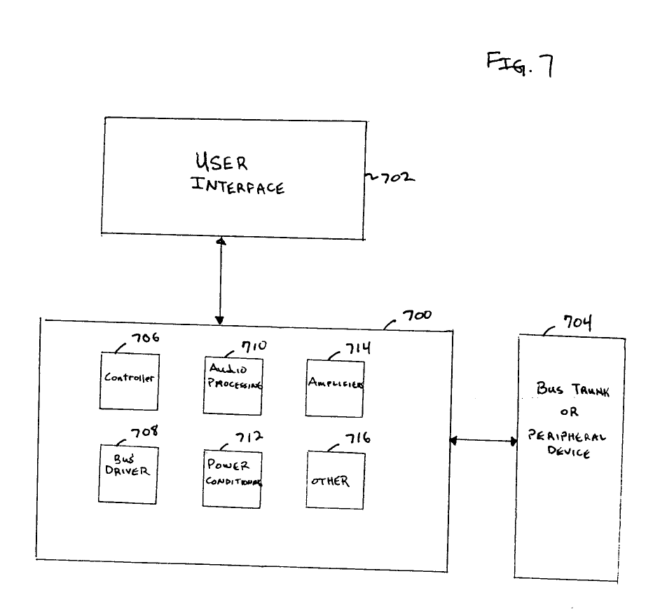

For example, FIG. 5 depicts how users may add a bus trunk 508 to the main hub controller 402 of FIG. 4 and provide expansion to accommodate a secondary hub 510 and one or more peripheral devices 512, 514, 516. Naturally, one or more peripheral devices 518 may also be added directly to the main hub controller 402 in addition to or without adding the bus trunk 508. The actual implementation will depend on user preference and capabilities of any individual hub controller. In some instances, the invention even contemplates that the main hub controller will altogether lack peripheral devices and such will only be found associated with the secondary hub controllers. FIG. 6 shows still another embodiment, especially that any given peripheral device 610 and/or user interface module 612 may be interchanged amongst the various hub controllers 614, 616. It even contemplates that each hub controller will have its own user interface module. Of course, the main hub controller can add a bus trunk 618 to support future expansion.

In FIG. 7, a block diagram of a preferred main hub controller is shown generally as 700. Connected thereto, as in FIG. 4, for example, is a user interface module 702 and a bus trunk or another peripheral device 704. In architecture, the components of the main hub controller 700 comprise discrete circuits interconnected via the functionality of wiring harnesses or physical connectors laid out on a common substrate such as a printed circuit board. Alternatively, its architecture comprises one or more application specific integrated circuits (ASICs), software modules, or combined hardware and software modules. Combinations of the foregoing or other embodiments are also embraced by the invention. Regardless, skilled artisans will appreciate that each of the components interacts with one another as necessary despite the lack of functional arrows in the drawing.

In function, the main hub controller's components include a controller 706, a bus driver 708, an audio processor 710, a power conditioner 712, one or more amplifiers 714 and other functionality 716. In one embodiment, the controller 706 includes a commercially available microprocessor, such as a Motorola brand 9S12 microprocessor. The bus driver includes components necessary to drive the bus, such as a CAN driver in the event the protocol selected is ISO 11898. The audio processing 710 includes a Phillips brand audio processor operable according to I²C functionality. The power conditioning 712 is circuitry that has an input of +12 vdc directly from the battery of the straddle vehicle. The output is a voltage of five, eight or twelve volts or other to run the various components of the topology. Since the input voltage is generally a very dirty signal, circuitry also exists to make the outputs well-regulated, clean and steady. The amplifiers 714 are circuits to make weak signals stronger and skilled artisans readily understand them. The other functionality 716 includes miscellaneous components such as those necessary to drive or interface with speakers, auxiliary devices, microphones, filters, cooling devices (e.g., fans) or the like. It also contemplates specific electrical components, such as capacitors, resistors, transistors, etc. to make the components operate properly with one another. Skilled artisans are well educated in this regard and no further discussion is necessary. Naturally, the user interface 702 and peripheral device 704 may also have their own microprocessors or controllers therein, depending upon the actual device implemented.

In FIG. 8, a preferred user interface module according to the present invention is shown generally as 800. In one aspect, the user interface module attaches electrically to the main hub controller. In another aspect, it resides on a handlebar 810 of a given straddle vehicle 820 via attachment of mechanical fasteners (not shown). In other aspects, the user interface module provides users with the option of implementing a single point of control for the entirety of peripheral devices that are configured in the bus topology, previously described, and greatly simplifies the prior art. When implemented, users no longer need dedicated wiring harnesses and dedicated control for pluralities of peripheral devices. They also need not fumble with various and numerous switches particular to a given peripheral device.

In a preferred embodiment, the user interface module includes a display 830 and a plurality of switches 832, 834, 836. The display 830 can be an LCD panel that displays user's selections in response to their manipulation of the switches. In other embodiments, the display avoids or compliments LCD technology with LED's, plasma technology or other known or hereafter invented technology. The function of the display is to provide a visual indication to the user regarding the control of the one or more peripheral devices. As illustrated, the display indicates FM 103.1 which corresponds to a scenario in which a peripheral device under control (e.g. FM radio) is presently tuned at a frequency of 103.1.

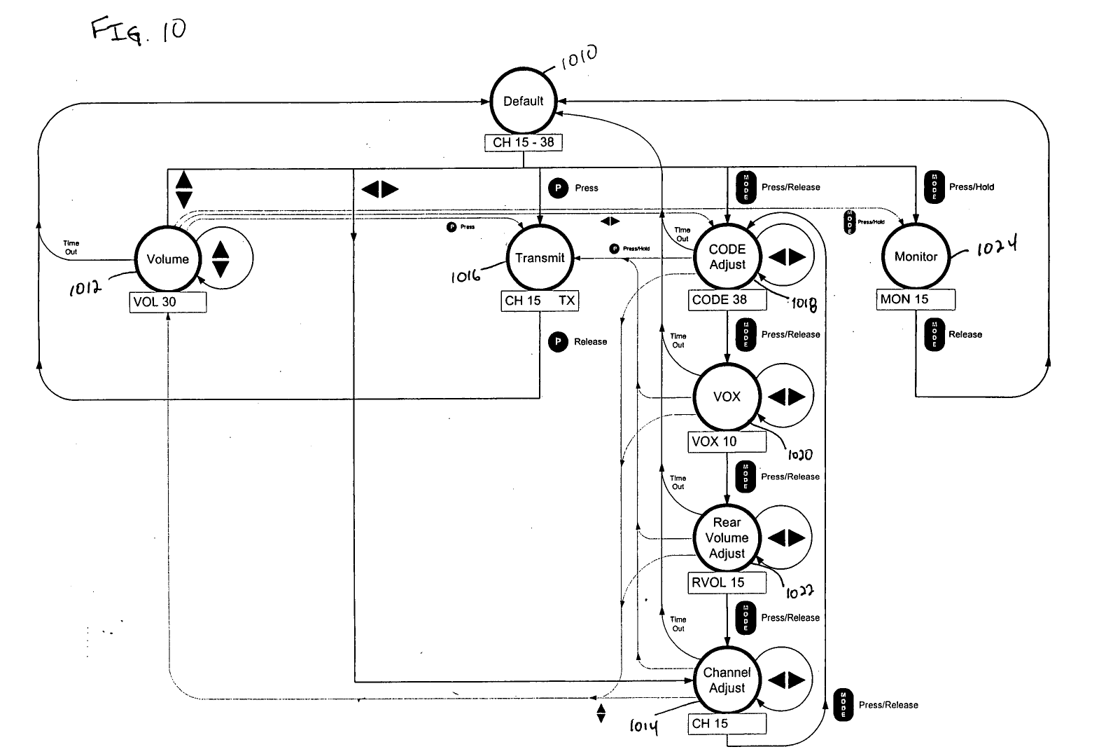

The switches include a preset switch 832, a four-way rocker switch 834 and a mode switch 836. In phantom, one or more fingers of a user's hand 850 can grasp or hold the handlebar 810 while a thumb can manipulate any of the switches. As is often found on motorcycles, for example, the preset and mode switches are of the press-and-hold or press-and-release variety. The four-way rocker switch 834, on the other hand, is of the joystick variety or of four discrete positions dictated by pressing one of the arrows thereon. In combination, these switches represent a relative advance in the arts. As will be seen in FIGS. 9 and 10, the functionality of a variety of peripheral devices can be controlled with just three switches, regardless of the device's function.

In physical regard, the display 830 mounts generally in-line with the handlebar so users can easily see its readout. The switches, however, mount beneath the handlebar. They also mount generally offset from a terminal end 862 of the handgrip 860 in the direction of arrow A. Because the rocker switch 834 has a generally larger surface-area compared to the preset and mode switches, it fits between the preset and the mode switches. In this manner, users can readily locate each of the switches during use without necessarily needing to look at them.

In function, the preset switch 832 generally adjusts one or more peripheral devices to a preset condition. The preset condition can represent a radio frequency, such as FM 103.1 as shown. The mode switch generally changes control from one of the peripheral devices to another. The rocker switch generally increases or decreases volume, bass, treble or other of a peripheral device under control, such as by manipulating the up or down arrows. With the left and right arrows, a user can switch between various functionality of the peripheral device under control. For example, if the peripheral device embodies an FM radio, the left and right arrows may allow for manually tuning the frequency to a higher a lower-frequency radio station.

With reference to FIGS. 9 and 10, state diagrams show the functionality obtained with the three-described switches of the user interface module of FIG. 8. In FIG. 9, the state diagram relates to an AM/FM radio including an auxiliary audio input while in FIG. 10 it relates to a standalone GMRS radio. Common to both, and a starting point for discussion, a default state 910, 1010 exists that sets the beginning or initial state for either the AM/FM radio or the GMRS radio such as upon power-up, for example. At state 910, the default is FM 107.7. At state 1010 the default is Channel 15, code 38 on a GMRS radio.

In FIG. 9, by depressing either of the up/down arrows of the rocker switch, the volume correspondingly increases or decreases as seen at state 912. Pressing of the left or right arrows of the rocker switch in a press-and-release fashion will cause the tuning of the frequency to change manually down or up, respectively, as seen at state 914. Conversely, pressing of the left or right arrows in a press-and-hold fashion will cause the frequency to enter a frequency-down or frequency-up seek, or automatic tuning, respectively (state 916).

Press-and-release operation of the mode switch will cause the source of the radio to sequentially cycle between FM, AM and an auxiliary input. These states are given as 918, 920 and 922 respectively. When switched to AM, the default changes to AM 870. The auxiliary input can be any of the fore-mentioned peripheral devices.

Press-and-hold of the mode switch will sequentially cause the cycle of Bass 924, Treble 926 and Volume 912 to occur. Once in these states, further pressing of the up/down arrows of the rocker switch will either increase or decrease the bass, the treble or the volume as indicated by the up/down arrows to the right side of these states.

Press-and-release operation of the preset switch 928 will tune the radio to various preset radio stations. Conversely, press-and-hold operation of the preset switch will enable the user to preset the stations 930 or to store the same 932. The number of presets will vary according to preference.

In FIG. 10, any pressing of the up/down arrows of the rocker switch will change the volume of the GMRS radio, state 1012. Pressing of the left and right arrows will decrease or increase the channel of the radio, state 1014.

Pressing of the preset switch will enable a user to transmit, state 1016. Preferably, such occurs via a microphone that interfaces with the main hub controller via the other functionality block 716, FIG. 7. Releasing of the switch stops or kills the transmission.

Press-and-release of the mode switch sequentially cycles the GMRS radio between code adjust 1018, VOX 1020, rear volume adjust 1022 and channel adjust 1014. Conversely, press-and-hold of the mode switch changes the monitor 1024.

In either FIG. 9 or 10, skilled artisans will appreciate that additional functionality is achieved in each of the state diagrams by following the various arrows between the states. Also, the states shown could be reconfigured by altering the pressing scheme of the same three switches without losing any functionality. The foregoing, therefore, is merely representative and not required. Also, other peripheral devices, such as cell phones, CB radios, CD players, etc., will have other programming specific to the functionality thereof when making them operate with the user interface module hereof.

The foregoing description is presented for purposes of illustration and description of the various aspects of the invention. The descriptions are not intended to be exhaustive or to limit the invention to the precise form disclosed. The embodiments described above were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A straddle vehicle, comprising a bus trunk and a main hub controller connected to said bus trunk for a user to control operation of one or more peripheral devices from a single location.

2. The straddle vehicle of claim 1, wherein said single location further includes a user interface module, said user interface module connected to said main hub controller.

3. The straddle vehicle of claim 2, wherein said user interface module connects to said main hub controller via said bus trunk.

4. The straddle vehicle of claim 1, wherein said single location resides on a handlebar of said straddle vehicle.

5. The straddle vehicle of claim 1, wherein said bus trunk operates according to a controller area network protocol.

6. A straddle vehicle, comprising:
a bus trunk;
one or more peripheral devices distributed about said straddle vehicle;
a main hub controller connected to said bus trunk, said one or more peripheral devices connected directly to or via said bus trunk to said main hub controller; and
a user interface module connected to said main hub controller for a user to control operation of said one or more peripheral devices.

7. The straddle vehicle of claim 6, further including a secondary hub controller connected to said bus trunk and having at least one peripheral device connected thereto.

8. The straddle vehicle of claim 6, wherein said bus trunk operates according to a controller area network protocol.

9. The straddle vehicle of claim 6, wherein said user interface module attaches to a handlebar of said straddle vehicle.

10. The straddle vehicle of claim 6, wherein said one or more peripheral devices includes one or more of an AM radio, an FM radio, an XM radio, a CB radio, a GMRS radio, a WB radio, a cell phone, a tape player, a CD player, an MP3 player and a radar detector.

11. A straddle vehicle having an expandable bus topology for a plurality of peripheral devices physically distributed about said straddle vehicle, comprising:
a bus trunk physically attached to said straddle vehicle;
a main hub controller electrically and physically connected to said bus trunk and being capable of connecting to one or more said peripheral devices or an additional bus trunk;
a secondary hub controller electrically and physically connected to said bus trunk and being capable of connecting to at least one said peripheral device; and
a user interface module connected to one of said main hub controller and said secondary hub controller to provide said user with a single point of control over said one or more peripheral devices.

12. The straddle vehicle of claim 11, wherein said user interface module attaches to a handlebar of said straddle vehicle.

13. The straddle vehicle of claim 11, wherein said bus trunk, said main hub controller, said secondary hub controller and said user interface module all operate according to a controller area network protocol.

14. The straddle vehicle of claim 11, wherein said plurality of peripheral devices include one or more of an AM radio, an FM radio, an XM radio, a CB radio, a GMRS radio, a WB radio, a cell phone, a tape player, a CD player, an MP3 player and a radar detector.

15. A straddle vehicle having an expandable bus topology for one or more peripheral devices physically distributed about said straddle vehicle, comprising:
a bus trunk connected to said straddle vehicle;
a main hub controller connected to said bus trunk and capable of connecting to said one or more peripheral devices or an additional bus trunk; and
a user interface module connected to said main hub controller to provide a user with a single point of control over said one or more peripheral devices.

16. The straddle vehicle of claim 15, further including a secondary hub controller connected to said bus trunk.

17. The straddle vehicle of claim 16, wherein at least one peripheral device connects to said secondary hub controller.

18. The straddle vehicle of claim 16, further including another secondary hub controller, said another secondary hub controller connecting to said additional bus trunk.

19. The straddle vehicle of claim 15, wherein said user interface module connects directly to said main hub controller.

20. A straddle vehicle including a handlebar comprising a user interface module for use with an expandable bus topology to provide a user with a single point of control over one or more peripheral devices physically distributed about said straddle vehicle, said user interface module having a four-way rocker switch beneath said handlebar that said user can manipulate with a thumb while still grasping said handlebar with one or more fingers of a same hand.

21. The straddle vehicle of claim 20, wherein said interface module operates in accordance with a controller area network protocol.

22. The straddle vehicle of claim 20, said user interface module further including a preset switch to adjust one of said one or more peripheral devices to a preset condition.

23. The straddle vehicle of claim 20, said user interface module further including a mode switch for changing control from one said peripheral device to another.

24. The straddle vehicle of claim 20, said user interface module further including a display that changes in response to user manipulation of said rocker switch.

25. A straddle vehicle, comprising a bus topology and a user interface module configured therewith for a single location of user control of one or more peripheral devices distributed about said straddle vehicle.

26. The straddle vehicle of claim 25, further including a bus trunk and a main hub controller connected thereto.

27. The straddle vehicle of claim 26, wherein said bus trunk and said main hub controller operate according to a controller area network protocol.

28. The straddle vehicle of claim 27, further including a secondary hub controller connected to said bus trunk, said one or more peripheral devices connected directly to said main hub controller or said secondary hub controller.

29. A method of controlling a plurality of peripheral devices from a single user location of a straddle vehicle, comprising:
configuring an expandable bus topology on said straddle vehicle including connecting a bus trunk to said straddle vehicle, said bus trunk operable according to a desired protocol;
configuring a user interface module and one or more peripheral devices distributed about said straddle vehicle to operate on said bus trunk via said desired protocol, said user interface module providing said single user location of control; and
adaptively configuring additional peripheral devices to operate on said bus trunk as desired.

30. The method of claim 29, further including connecting a main hub controller to said bus trunk, said main hub controller operable according to said desired protocol and adapted to take user commands from said user interface module for controlling said one or more peripheral devices.

31. The method of claim 29, further including configuring said desired protocol to operate according to a controller area network protocol.

32. The method of claim 29, further including connecting a secondary hub controller to said bus trunk, said secondary hub controller operable according to said desired protocol.

33. The method of claim 32, further including connecting another peripheral device to said secondary hub controller.

34. The method of claim 29, further including displaying a selection on said user interface module in response to a user initiated command of said one or more peripheral devices.
